(19) United States
(12) Patent Application Publication
(10) Pub. No.: US 2006/0008126 A1
(43) Pub. Date: Jan. 12, 2006

(54) Validation of fingerprint-based criminal background check results

(76) Inventors: Robert W. Holloran, Ocala, FL (US); Michael M. Powers, Hilliard, OH (US); George R. Boraiko, Valrico, FL (US); Alan L. Thomas, Lakeland, FL (US)

Correspondence Address: DOUGLAS WM. MASSINGER, ESQUIRE;MASSINGER LAW OFFICES, 887 N.E. 100 STREET, OCALA, FL, 34479, US

(21) Appl. No.: 10/883,114

(22) Filed: Jun. 30, 2004

(51) Int. Cl. G06K 9/00

(52) U.S. Cl. 382/124

(57) ABSTRACT

A system for employers and other organizations desiring the results of fingerprint-based criminal history background checks to validate that the intended applicants' fingerprints were in fact used for the checks. This system includes: 1. A compatible method for capturing individual applicants' fingerprints for the purpose of conducting fingerprint-based criminal history background checks at collection points and means for transmitting the applicants' fingerprints and biographical data to an Automated Fingerprint Image System (AFIS); 2. A compatible device at the employer's location that captures an electronic image of one or more of the applicant's fingerprints and means for transmitting these fingerprints and biographical data to an Automated Fingerprint Image System (AFIS). These prints are captured solely for the purpose of validating that the applicants' fingerprints were captured at the collection points and were used for the criminal history background checks; and 3. An AFIS that: (1) stores the fingerprints and biographical data submitted for fingerprint-based criminal history background checks at one or more criminal history repositories, (2) stores the results of the fingerprint-based criminal history background checks, i.e., whether the applicant has a criminal history record, and (3) compares the validation prints with the prints submitted for the criminal history background check under the applicants' biographical data.

### FIELD OF THE INVENTION

The subject invention relates to the performance of fingerprint-based criminal background checks in general, and to systems, apparatus and methods for validating the results thereof in particular.

### BACKGROUND OF THE INVENTION

Fingerprint-based criminal history background checks are permitted for some, but not all, non-criminal justice purposes. For example, the Congress requires fingerprint-based background checks of FBI's National Criminal Information Center (NCIC) for commercial airline pilots and authorizes, without mandating them, for teachers, volunteers in support of children and other vulnerable populations. However, most private sector employers do not have access to the NCIC for making employment decisions. Which employers are permitted access to the individual state criminal history repositories for fingerprint-based criminal history background checks for non-criminal justice purposes varies from state to state.

Fingerprint-based criminal history background checks conducted for permitted civil, (non-criminal justice) purposes start when an individual applicant presents him/herself to a potential employer (often referred to herein as an “Authorized End-User”) in an employment class that requires a pre-employment fingerprint-based criminal history background check. Depending upon the individual state's enabling legislation, the results of the criminal history background check may or may not be seen, in whole or in part, by the Authorized End-User. The results of the background check are commonly referred to as a “Criminal History Record Information” or “CHRI”, which is comprised of two components: a “Summary” of whether or not there were “hits” (i.e. criminal records located) in the state or federal criminal history repository, and a “Rapsheet” including detailed information concerning each criminal record (i.e., date of arrest, charges, grade of offenses, disposition, etc.). Unless specifically stated to the contrary, the term “Rapsheet” when used herein is intended to refer to the entire CHRI.

The entity authorized by statute to review the Rapsheet is referred to herein as an Authorized Recipient, and may be an outside review organization (for example, a state agency) who performs a suitability review and subsequently provides the results of that review, as permitted by statute, to the Authorized End-User. In the current state of the art, after an individual presents him/herself to the Authorized End-User, the End-User orders a fingerprint-based criminal history background check and directs the individual to a location suitability equipped for capturing fingerprints in a manner that is compatible with the applicable criminal history repository to be searched (that is, the state criminal history repository and/or the NCIC). Such capture processes include: (1) traditional rolled ink and fingerprint cards, which at some point in the process may be converted to digital form with a scanner so they can be compared using the repository's automated fingerprint identification system (“AFIS”) and (2) livescan devices that capture the applicants' fingerprints through optical, ultrasonic or other suitable means and convert them to digital representations that can be stored and transmitted electronically.

After being transmitted to the applicable criminal history repository, the repository's AFIS compares the fingerprints submitted for the background check with the offenders' fingerprints contained in the repository. The results of such fingerprint-based background checks are provided to the Authorized Recipient that ordered the checks. In those cases when the Authorized Recipients do not capture the applicants' fingerprints, there is no known way for the Authorized Recipients to validate that the intended applicants' fingerprints were actually used for the background checks, that is, that someone other than the applicants' fingerprints were captured, invalidating the results. In other words, if the Authorized Recipients do not have means for validating the results, applicants with criminal records that would disqualify them from holding positions, could have had people, who do not have a criminal record, impersonate them at the locations where the fingerprints are captured, defeating the intended purpose of the criminal history background checks. Even when the fingerprints are captured for civil, non-criminal justice purposes at law enforcement agencies, the personnel who staff these facilities often are not well equipped, or well motivated, to accurately verify that the intended applicants' fingerprints are being captured.

To further complicate matters, by law the FBI, and some of the state criminal history repositories, are prohibited from retaining the fingerprints submitted for civil, non-criminal justice purposes, thereby preventing subsequent validation by the Authorized Recipients. Clearly there exists a need for overcoming the above described shortcomings and limitations of the prior art. It is desirable to have an independent, trusted third-party organization maintain an applicant's fingerprints (with his/her permission) for purposes of: (1) validating the results of his/her criminal history background checks, and (2) re-submission of his/her prints for subsequent fingerprint-based background checks.

### SUMMARY OF THE INVENTION

The subject invention relates generally to systems, methods and software implemented devices for the positive validation of fingerprint-based criminal background check results which said systems, methods and apparatus are together herein referred to as a “Fingerprint Validation System”. All embodiments of the subject Fingerprint Validation System are comprised of two primary components: 1) a centralized core processing application suite (hereinafter “Core Processing Application Suite” or “CPAS”) which carries out primary functions of the subject invention as described in detail herein, and 2) first and second fingerprint collection means, the first being located at a fingerprint collection facility and used in performing the background check itself, and the second being used for validating the results of said search. These primary components are electronically linked together and are capable of electronically interacting with the fingerprint collection facility and at least one criminal record repository via communications means as more fully described herein. In general, the Core Processing Application Suite compares fingerprints captured by the first fingerprint collection means located at the fingerprint collection facility from an individual purporting to be the Applicant with fingerprints captured by the second fingerprint collection means from the known Applicant while in the presence of the prospective employer or agent thereof to determine whether they are a match, thereby validating or invalidating the results of the criminal background check (i.e., that the fingerprints of the Applicant were, in fact, used for the background check).

The Core Processing Application Suite therefore acts as a trusted, third party acting on behalf of both the applicant to be screened (“Applicant”) and the Authorized End-User in response to a request for a fingerprint-based criminal background check for civil, non-criminal justice purposes, such as employment background screening or as a result of an individual's Freedom of Information Act request. All communications between the primary components of the subject invention preferably take place over secure and/or encrypted data communications channels.

The subject systems, methods and software implemented devices for the positive validation of fingerprint-based criminal background check results are utilized in four (4) basic scenarios:
1) where the Core Processing Application Suite submitting the fingerprint-based background check request to the State and/or FBI Fingerprint-based criminal history Repositories is not authorized to receive and forward the Rapsheet to the Authorized Recipient;
2) where the Centralized System submitting the fingerprint-based background check request to the Repositories is authorized to receive and forward the Rapsheet to the Authorized Recipient;
3) where an Applicant requests a fingerprint-based background check on him/herself under a Freedom of Information Act (FOIA) request, submits the results to a prospective employer as proof of suitability, and the employer subsequently desires to validate that the Applicant's fingerprints were used for the background check and that the number of records identified on the Rapsheet returned by the FBI to the Applicant are accurate; and
4) where an Applicant has previously had his/her fingerprints captured and stored in the Centralized Systems' AFIS database, and an Authorized End-User desires to validate that the Applicant's fingerprints exist therein and to resubmit the existing fingerprint images for purposes of obtaining a current Rapsheet with permission of the Applicant.

As noted above, one of the primary differences in the scenarios is how the delivery of the Rapsheet is handled, which is mandated by State and/or Federal regulations. Regardless of the specific scenario involved, it should be appreciated that the subject invention provides a positive means of validating that the fingerprint images submitted for a criminal history background check were truly those of the Applicant.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is, therefore, a primary object of the subject invention to provide systems, methods and software implemented devices for the positive validation of fingerprint-based criminal background check results.

Another primary object of the subject invention is to provide systems, methods and software implemented devices for the positive validation of fingerprint-based criminal background check results employing fingerprint validation means that do not require the Authorized End-User to be co-located with the Fingerprint Collection Facility in order to physically verify that the Applicant's fingerprints are the fingerprints being submitted for the background check.

These together with other objects of the invention, along with the various features of novelty which characterize the invention, are pointed out with particularity in the claims annexed to and forming a part of this disclosure. For a better understanding of the invention, its advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed flow diagrams and drawings wherein:

FIG. 1 is a flow diagram illustrating a first embodiment of the subject Fingerprint Validation System where an Outside Review Authority is the Authorized Recipient and the Fingerprint Validation System is not authorized to forward the Rapsheet, but is authorized to receive a Summary of the CHRI.

FIG. 2 is a simplified drawing of INSET A of FIG. 1 where the Authorized End-User is the Authorized Recipient of the CHRI and the Fingerprint Validation System is not authorized to receive the Applicant's Rapsheet, but is authorized to receive a Summary of the CHRI.

FIG. 3 is a flow diagram illustrating a third embodiment of the subject Fingerprint Validation System detailing the differences in the routing of the Applicant's Rapsheet where an Outside Review Authority is the Authorized Recipient and the subject Fingerprint Validation System is authorized to forward the Applicant's Rapsheet to the Authorized Recipient.

FIG. 4 is a simplified drawing of INSET B of FIG. 3 where the Authorized End-User is the Authorized Recipient of the CHRI and the Fingerprint Validation System is authorized to forward the Applicant's Rapsheet to the Authorized Recipient.

FIG. 5 is a flow diagram illustrating yet another embodiment of the subject Fingerprint Validation System where an individual requests a fingerprint-based background check on him/herself under the Freedom of Information Act (FOIA), submits it to the Employer as proof of suitability and the Employer subsequently verifies that the individual's fingerprints were used to request the CHRI and to validate the number of records identified on the Rapsheet returned by the FBI to the Applicant.

FIG. 6 is a flow diagram of a final embodiment of the subject Fingerprint Validation System detailing the differences in the process for resubmitting an Applicant's fingerprint-based criminal history background check when the Applicant has previously had his/her fingerprints captured and stored in the Core Processing Application Suite's AFIS Database.

### DETAILED DESCRIPTION OF THE PREFERRED EMBODIMENT

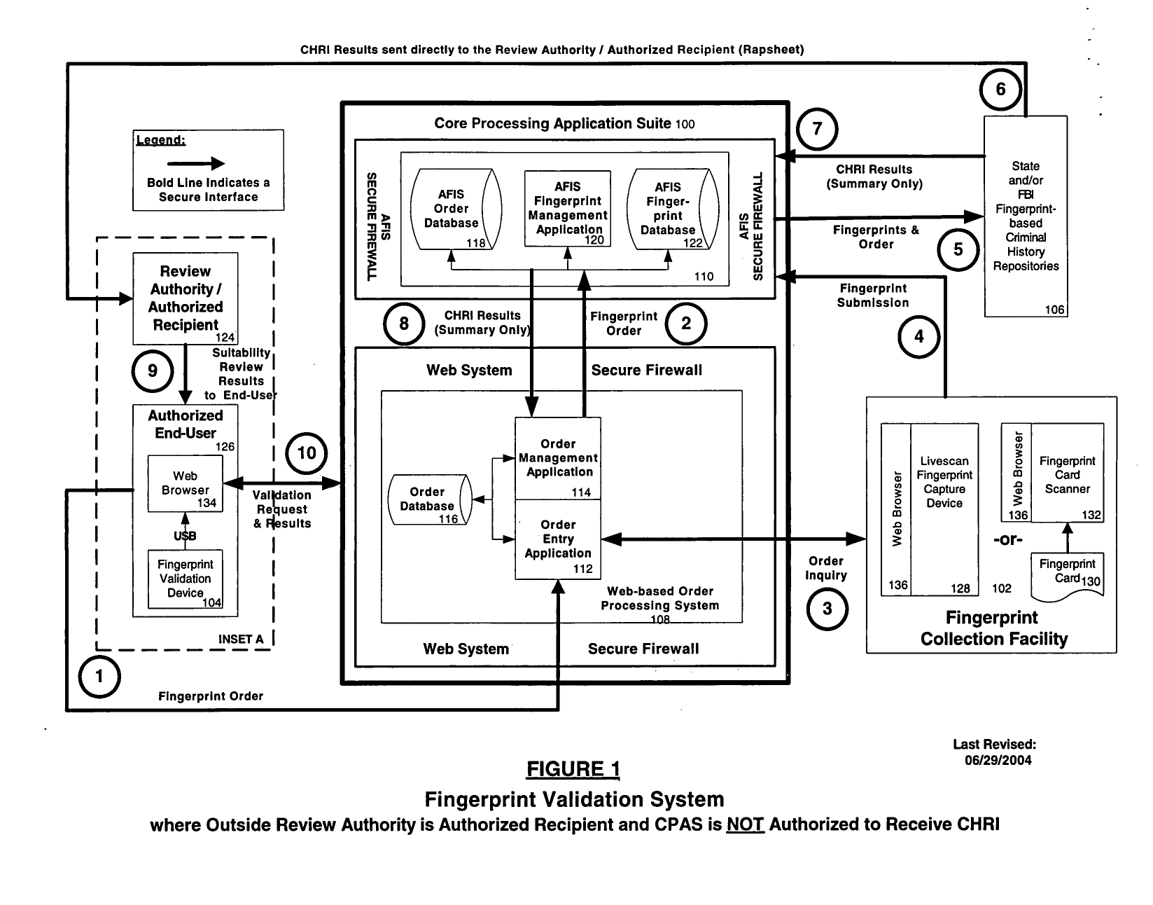

The subject invention relates generally to systems, methods and software implemented devices for the positive validation of fingerprint-based criminal background check results and are together referred to herein generally as a “Fingerprint Validation System”. Referring to the flow diagrams of FIGS. 1-6, it may be observed that all embodiments of the subject Fingerprint Validation System are comprised of two primary components: 1) a centralized core processing application suite 100 (hereinafter “Core Processing Application Suite” or “CPAS”), and 2) first and second fingerprint collection means 102 and 104, respectively; the first being located at a fingerprint collection facility and used in performing the background check itself, and the second being preferably located with the party desiring validation of the search results and being used for that purpose. These primary components are electronically linked together and are capable of electronically interacting with the fingerprint collection facility (“FCF”) housing first fingerprint collection means 102 and at least one criminal record repository 106 via communications means as more fully described herein. Among other things, the System Hub 100 is responsible for comparing fingerprints captured by first fingerprint capture means 102 located at the FCF from an individual purporting to be the Applicant with fingerprints captured by second fingerprint collection means 104 from the actual Applicant while in the presence of the prospective employer or agent thereof to determine whether they are a match, thereby validating or invalidating the results of the criminal background check (i.e., that the fingerprints submitted for the criminal history background check were truly those of the Applicant).

System Hub 100 is itself comprised of two major sub-components: 1) an Internet or web-based Order Processing System 108 (hereinafter “OPS 108”) and, 2) a commercial Automated Fingerprint Identification System 110 (hereinafter “AFIS 110”). Web-based OPS 108 is a collection of commercially available or custom-written software applications that collectively manage and oversee the input, processing, reporting and billing of a fingerprint-based background check. The subject invention should not be construed to be limited to either commercially available or custom-written software devices, as OPS 108 is modularly designed to accept and seamlessly integrate with a variety of software devices. The three basic components of the OPS are: 1) an Order Entry Application 112, 2) an Order Management Application 114 and 3) an Order Database 116. Order Entry Application 112 is a software-implemented device that provides a human-machine interface between an Authorized Recipient 124 and OPS 108. Order Management Application 114 is a software-implemented device that stores, retrieves, collates, reports or otherwise manages the data collected by Order Entry Application 112 and other hardware or software implemented devices.

Both the Order Entry and Order Management Applications 112 and 114, respectively, store their data in Order Database 116. Order Database 116 contains all data regarding the fingerprint-based criminal background check order, including input fields, status fields, CHRI Result Summaries, and other such data as is required to fully implement the various embodiments of the subject invention. Order Database 116 is developed and maintained on commercially available database platforms, with no preference being given to the specific platform employed.

The second sub-component required to implement System Hub 100 of the subject Fingerprint Validation System is the aforementioned commercial Automated Fingerprint Identification System (AFIS 110). The three basic components of AFIS 110 are: 1) an AFIS Order Database 118, 2) an AFIS Fingerprint Management Application 120, and 3) an AFIS Fingerprint Database 122. In order for System Hub 100 to access a State or FBI fingerprint-based criminal history repository 106 and the information contained therein, it is necessary that AFIS 110 be from a vendor, and of a type and specification that can interface with repository 106. AFIS 110 presents a means for comparing at least one fingerprint captured by Fingerprint Validation Device 104 and submitted by an Authorized End-User 126 with the fingerprint(s) from corresponding digits captured by fingerprint collection means 102 to determine whether a match exists. AFIS 110 further serves as a means for determining whether fingerprints submitted for a criminal background check have been previously submitted under a different name. Finally, AFIS 110 provides a means for retaining all fingerprints submitted until, at a minimum, Authorized End-User 126 has used the Subject Fingerprint Validation System to verify the Applicant's fingerprints and criminal background history results.

The aforementioned fingerprint capture facility housing first fingerprint collection means 102 is preferably any facility with personnel trained to operate hardware and/or software implemented devices capable of capturing:
1) an electronic representation of a set of fingerprints in a controlled environment using a Livescan Fingerprint Capture Device 128, or
2) a traditional rolled ink fingerprint card 130 which is subsequently scanned into an electronic image set using a Fingerprint Scanning Device 132.
   Examples of such facilities could be Drug Screening Collection facilities, Department of Motor Vehicle Driver's License offices, Department of Transportation Weigh Stations, schools or any other facility that meets the aforementioned requirements. As used herein, the term “Livescan” is intended to mean hardware and software implemented devices that can capture either “flat” or “rolled” fingerprint images, which are the two technologies currently available. “Flat” fingerprints are defined as images captured by the technique of placing the finger or fingers flat on a scanning device and capturing an electronic image. “Rolled” fingerprints are defined as images captured by the technique of “rolling” the finger to capture a fingerprint image from nail-bed to nail-bed. It should be appreciated that the “rolled” and “flat” Livescan technologies currently standard in the industry are not intended to be limiting, particularly in the event other technologies become available, but rather the Livescan (or other) fingerprint capture devices are considered to be a “modular” component of the invention and can be exchanged for another capture device, Livescan or otherwise, provided that:
1) Each device is from a vendor, and of a type and specification to be approved by the Federal Bureau of Investigation and residing on their “IAFIS Approved Products List”, and
2) Each device is interoperable with the applicable State Repository accessed by the subject invention and with OPS 108 of System Hub 100.

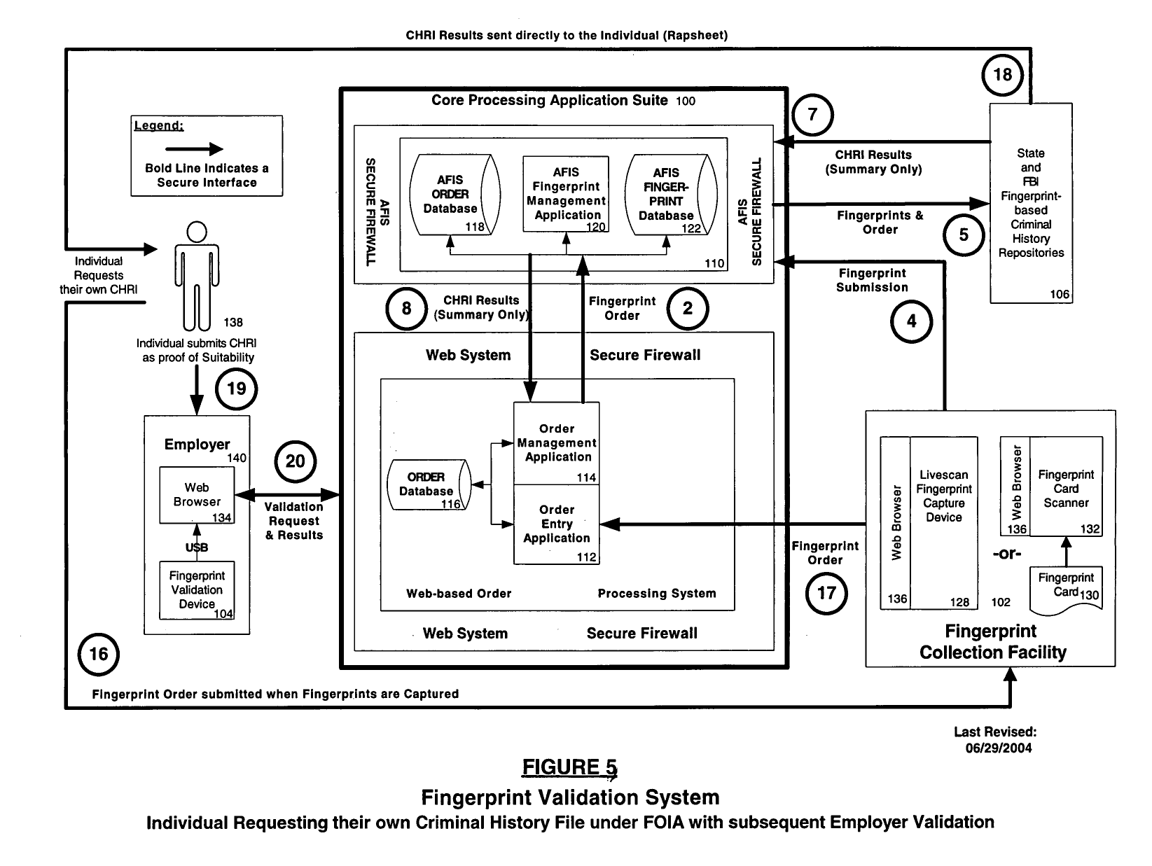

Authorized End-User 126 or its agent (“Employer”, in the case of FIG. 5) of the subject invention will be required to have and control second fingerprint collection means 104 (hereinafter also known as “Fingerprint Validation Device 104” or “FVD 104”) which is a hardware and software implemented device. FVD 104 is used to capture a fingerprint or set of fingerprints from the Applicant in order to allow Authorized End-User 126 (or Employer) to verify the Applicant's set of fingerprints against the set of fingerprints submitted to Repository 106 for the background check and subsequently stored in Centralized System's AFIS Fingerprint Database. There are many types of commercially produced FVD's and related technologies; and the subject invention should not be limited to these technologies in the event other technologies become available as FVD 104 is considered to be “modular” within the preferred embodiment of the invention and can be exchanged for another FVD provided that:
1) Each device is from a vendor, and of a type and specification to be approved by the Federal Bureau of Investigation and residing on their “IAFIS Approved Products List”, and
2) Each device is interoperable with the applicable State Repository accessed by the subject invention and with OPS 108 of System Hub 100.

Each of the above described components and sub-components of the subject Fingerprint Validation System are stored on (or in the case of the peripheral fingerprint capture devices are associated with) at least one computer (generally a personal computer) or computer server which normally includes or is otherwise associated with internal and external data storage means and media, processing apparatus, an appropriate software architecture, a monitor, input apparatus such as a keyboard, mouse or pointing device and a printer. The computers and/or computer servers may be part of a network comprised of either or both a generalized network environment or the Internet. Each of Repository 106, OPS 108, and AFIS 110 include a search architecture responsive to inputs by the users for causing or initiating searches of their respective databases, and for processing and reporting the corresponding search results as described in the Examples below. Each software architecture associated with Repository 106, OPS 108, and AFIS 110 is comprised of at least one software application which may be developed in a variety of programming languages to carry out the steps of the subject methods described herein. It should be further noted that all communications between hardware and software implemented devices of the subject invention are preferably made over secure communications lines. Secure communications lines can be defined as using, singly or in combination, any or all of the following:
1) Commercially available data encryption methods, techniques and software-implemented devices,
2) Commercially available Internet-based Protocols, such as Secure Sockets Layer (SSL) and Secure Hypertext Transfer Protocol (HTTPS://),
3) Commercially available software and hardware firewalls that support Virtual Private Networks (VPN) protocols and technologies,
4) Non-commercial, private, secure law enforcement networks such as the Federal Bureau of Investigation Criminal Justice Information Services Wide-Area Network (FBI CJIS WAN) or the National Law Enforcement Telecommunications System (NLETS) or,
5) Other non-commercial private networks.

### Methods of Use

All of the essential components of the subject Fingerprint Validation System having now been described in detail, attention is now turned to their methods of use and corresponding advantages, first generally and then by way of Examples. Each embodiment of the subject invention involves a methodology using the above described hardware and software implemented devices. An important aspect of the subject invention is that such methods do not require Authorized Recipient 124 to be co-located with the Fingerprint Collection Facility in order to physically verify that the Applicant's fingerprints are the fingerprints being submitted thereto for his or her criminal background check. Moreover, by retaining the fingerprint images submitted to each Repository 106 in AFIS Fingerprint Database 122 of System Hub 100, an Authorized End-User 126 can validate a Rapsheet by submitting at least one validation fingerprint (usually one or two fingerprints from the Applicant taken in the presence of the Authorized End-User). AFIS 110 performs a one-to-one match against the at least one fingerprint in AFIS Fingerprint Database 122 to validate the submitted comparison sample(s). The validation process using AFIS Fingerprint Database 122 of System Hub 100 ensures that the Applicant's fingerprints were the ones used to request and perform the background check. Retention of the fingerprint images in AFIS Fingerprint Database 122 also allows the Database to be subsequently searched to determine if the Applicant's fingerprints have been previously submitted under a different name (i.e., an alias). The following Examples demonstrate in greater detail the various embodiments of the subject validation processes employing the above described subject apparatus of the invention.

### EXAMPLES

As previously stated in the above Summary, the subject systems, methods and software implemented devices for the positive validation of fingerprint-based criminal background check results are utilized in four (4) basic scenarios. Each such scenario, together with its corresponding Figure, is discussed in the following Examples.

As a preliminary matter it should be appreciated that current State and Federal legislation approach the dissemination of an offender's Rapsheet differently. Some legislation requires that the Rapsheet be sent directly to the Authorized Recipient, either by Fax, postal mail or secure e-mail, whereas other legislative bodies may allow a third party system, such as the subject Fingerprint Validation System, to forward the Rapsheet to the Authorized Recipient. In those cases where the subject Fingerprint Validation System is permitted to forward the Rapsheet to the Authorized Recipient, it should be noted that in the preferred embodiments the Rapsheet is never permanently stored on either the Centralized Systems Hub's AFIS Database or Order Processing Database although the invention is compatible with other systems that do so.

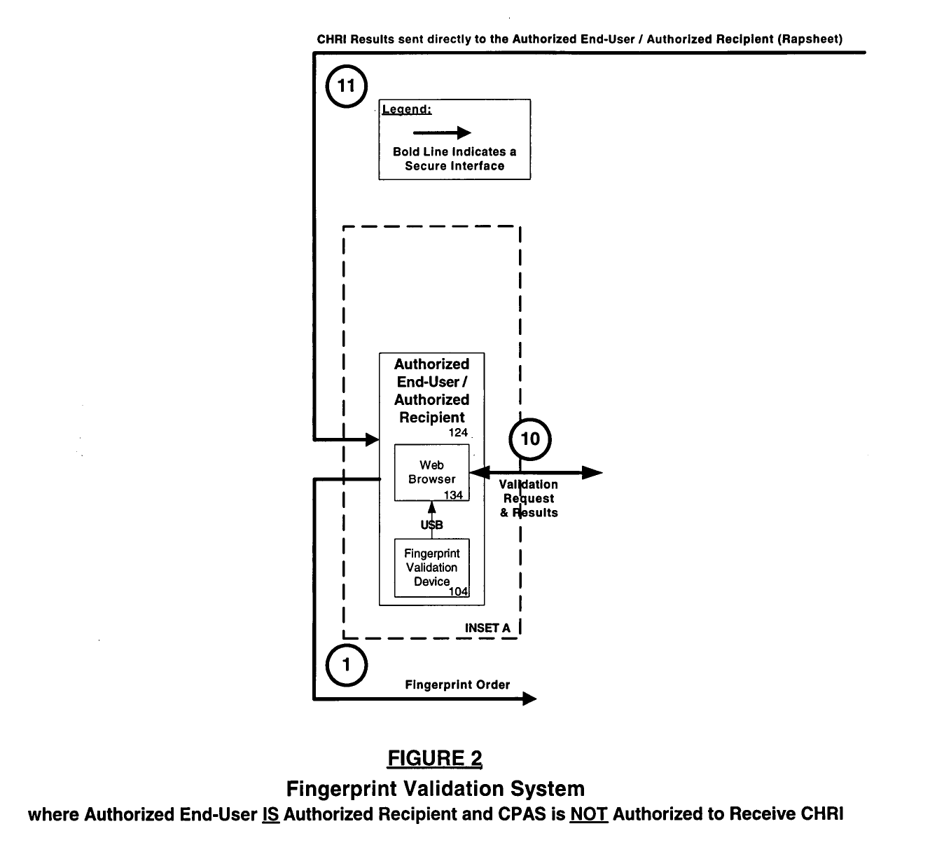

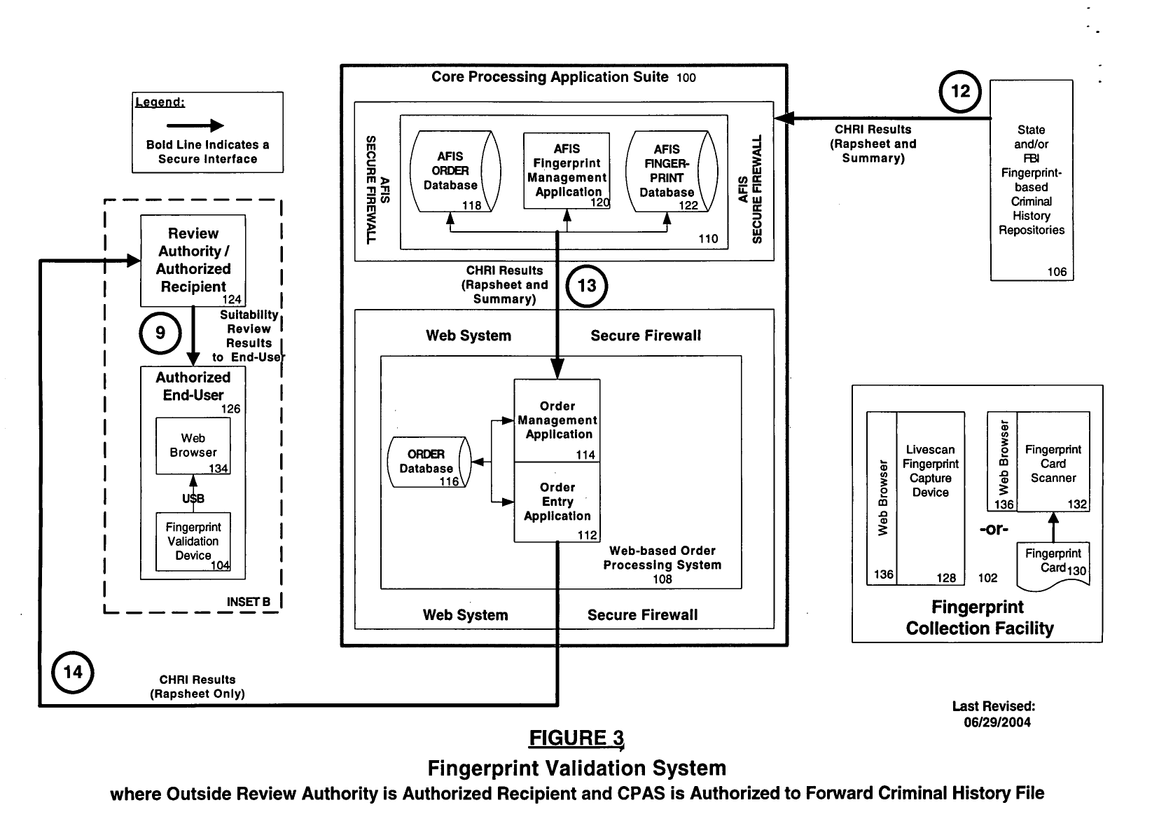

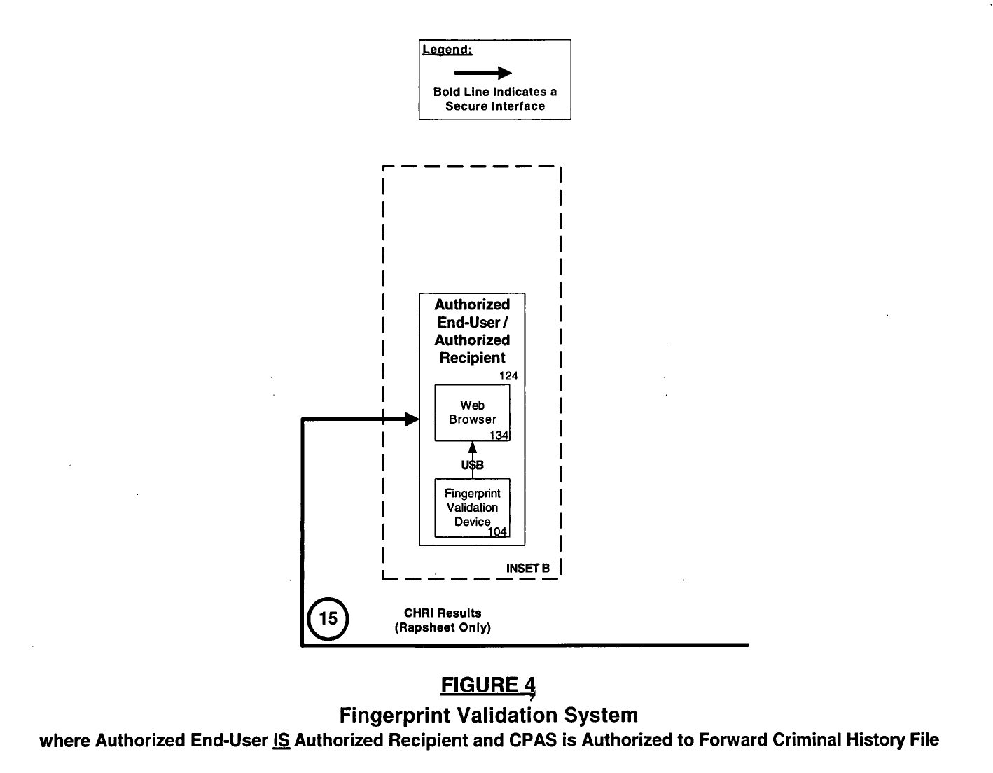

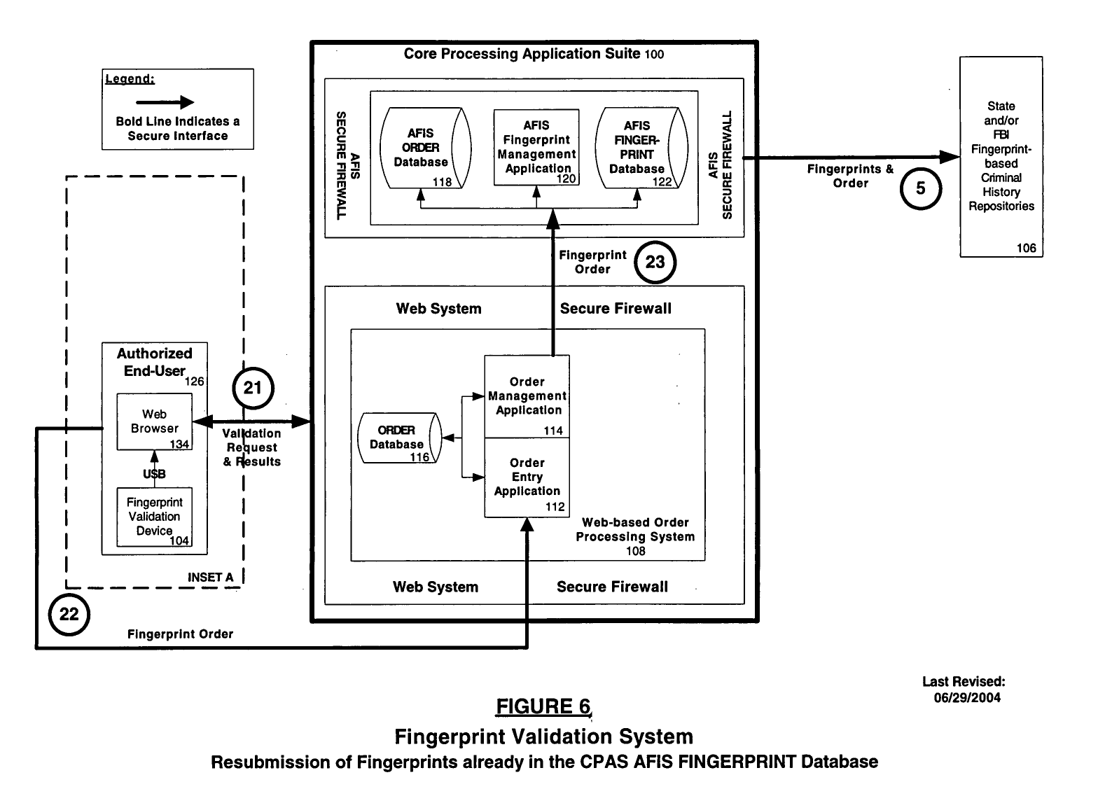

We now turn to a brief overview of the Examples. FIG. 1 illustrates the scenario where the subject Fingerprint Validation System is not authorized to forward the Rapsheet and the Authorized Recipient is an Outside Review Authority. In this scenario, the Rapsheet is sent to the Review Authority, which performs the suitability review of the Applicant's Rapsheet and informs the Authorized End-User of the results of the suitability review. FIG. 2 illustrates the differences in the scenario depicted in FIG. 1 when the Authorized Recipient and Authorized End-User are the same entities. FIGS. 3 and 4 illustrate the routing changes in the Rapsheet that occur when the subject Fingerprint Validation System is authorized to forward the Rapsheet to the Authorized Recipient. FIG. 3 illustrates the routing when the Authorized Recipient is an Outside Review Authority. FIG. 4 depicts the differences when the Authorized End-User is the Authorized Recipient. FIG. 5 illustrates the scenario where an individual requests a fingerprint-based background check on him/herself under a Freedom of Information Act (FOIA) request, and subsequently provides the resulting Rapsheet to an employer who, in turn, uses the subject Fingerprint Validation System to validate that the individual's fingerprints were the ones submitted for the background check and to validate the number of records identified on the Rapsheet returned by the FBI to the Applicant. Finally, FIG. 6 illustrates the scenario where the Applicant has previously had his/her fingerprints captured and stored in AFIS Fingerprint Database 120 of the subject Fingerprint Validation System; and the Authorized End-User validates that the Applicant's fingerprints exist in the Database and requests resubmittal of the stored fingerprint images. Note that certain steps of the subject methods of the Fingerprint Validation System are designated in the Figures by inscribed reference numerals and the indicator “(Action#)” in the corresponding text.

The scenarios applicable to the subject invention having been briefly described, reference is now made to FIG. 1 which illustrates a first embodiment of the subject systems, apparatus and methods of validating fingerprint-based criminal background check results where the Authorized Recipient 124 is an outside review authority and the subject Fingerprint Validation System is not authorized to forward the Rapsheet to said authority. In this embodiment, the Applicant authorizes Authorized End-User 126 to run a fingerprint-based criminal background check on the Applicant. Authorized End-User 126 uses web browser 134 to access the subject Fingerprint Validation System and enters a fingerprint order (Action 1) via web-based Order Entry Application 112. Order Entry Application 112 creates a Fingerprint Order in Order Database 116 of OPS 108, and Order Management Application 114 immediately forwards that order (Action 2) to AFIS Fingerprint Management Application 120 which directs the order be stored in AFIS Order Database 118. Authorized End-User 126 directs the Applicant to first fingerprint collection means 102 located at a Fingerprint Collection Facility in order to electronically capture his/her fingerprint images, and optionally capture the photograph and Driver's License information of the Applicant. When the Applicant arrives at the FCF, the FCF technician uses FCF web browser 136 associated with first fingerprint collection means 102 to access a web-based inquiry form (Action 3) on Order Entry Application 112 to verify that there is a fingerprint capture order for the Applicant. The FCF technician captures the Applicant's fingerprint images, (and optional) photograph and Driver's License (to capture the Applicant's personal information) using the Livescan (or other) Fingerprint Capture Device 128 and transmits the images (Action 4) to AFIS Fingerprint Management Application 120. AFIS Fingerprint Management Application 128 stores the images in AFIS Fingerprint Database 122. AFIS Fingerprint Management Application 128 builds a fingerprint-based criminal background check Request from the fingerprint images on AFIS Fingerprint Database 122 and AFIS Order Database 118 and then transmits the Request (Action 5) to the appropriate Criminal History Repository 106. Criminal History Repository 106 performs the background check and sends the Rapsheet (Action 6) directly to the Review Authority/Authorized Recipient 124 as specified in the Fingerprint Order. Repository 106 also sends a CHRI Summary (Action 7) back to the transmitting AFIS Fingerprint Management Application 128. AFIS Fingerprint Management Application 128, after logging the Summary into its AFIS Order Database 118, forwards the CHRI Summary (Action 8) to Order Management Application 114 and the summary results are stored in Order Database 116.

After Review Authority/Authorized Recipient 124 has reviewed the Rapsheet and made a suitability determination on the Applicant, Review Authority/Authorized Recipient 124 sends the results of the Suitability Review (Action 9) to Authorized End-User 126. Authorized End-User 126 uses second fingerprint collection means 104 (aka Fingerprint Validation Device 104) to capture at least one comparison fingerprint from the Applicant, uses web browser 134 to obtain an Order Number fom CPAS 100, and sends a Validation Request (Action 10) to AFIS Fingerprint Management Application 120 for validation of the fingerprints used for the background check. AFIS Fingerprint Management Application 120 performs a one-to-one match on the fingerprints submitted against the fingerprints captured in AFIS Fingerprint Database 122 used for the background check and returns a response to the Authorized End-User 126. A positive response (wherein the fingerprints match) indicates to Authorized End-User 126 that it was in fact the Applicant's fingerprints that were submitted for that order, thus positively linking the Applicant and the CHRI Rapsheet. A negative response indicates a likelihood that a fraudulent set of fingerprints were submitted and further investigation by the Authorized Recipient 124 is required.

The process detailed in FIG. 2 is identical to that of FIG. 1 with the exception of INSET A of FIGS. 1 and 2. In the event that Authorized End-User 126 is the Authorized Recipient 124 of the CHRI Rapsheet, the Rapsheet is delivered (Action 11) directly to the Authorized End-User 126. All other processes are identical to the example illustrated in FIG. 1.

Reference is now made to FIG. 3 in which there is illustrated in flow diagram form the a second embodiment of the subject Fingerprint Validation System wherein the Authorized Recipient is an Outside Review Authority and the System Hub 100 is authorized to forward the CHRI Rapsheet to the Authorized Recipient 124. The process for ordering and submitting the background check order to Repository 106 is identical to that described in Example 1. When System Hub 100 is authorized to forward the CHRI Rapsheet to Authorized Recipient 124, Repository 106 forwards both the CHRI Rapsheet and Summary (Action 12) to AFIS Fingerprint Management Application 120. AFIS Fingerprint Management Application 120 stores ONLY the CHRI Summary into its AFIS Order Database 118 and forwards both the CHRI Rapsheet and Summary (Action 13) to Order Management Application 114. Order Management Application 114 stores ONLY the CHRI Summary in Order Database 116 and forwards the CHRI Rapsheet (Action 14) to Review Authority/Authorized Recipient 124. After Review Authority/Authorized Recipient 124 has reviewed the CHRI Rapsheet and made a suitability determination on the Applicant, Review Authority/Authorized Recipient 124 sends the results of the Suitability Review (Action 9) to Authorized End-User 126. The process then followed by Authorized End-User 126 to validate that the Rapsheet applies to the Applicant by validating his/her at least one fingerprint sample against AFIS Fingerprint Database 122 is identical to that described in Example 1. Note that in a preferred embodiment neither the AFIS Order Database 118 nor the Order Database 116 will permanently store a copy of the Applicant's CHRI Rapsheet, although the invention is compatible with systems that do so.

The process of Example 4 is identical to that described in Example 3 with the exception of those changes illustrated in INSET B of FIGS. 3 and 4. In the event that the Authorized End-User is the Authorized Recipient of the CHRI Rapsheet, the Rapsheet is delivered (Action 15) directly to Authorized End-User 126. All other processes are identical to those described in Example 3.

Reference is now made to FIG. 5 in which there is illustrated in flow diagram form another embodiment of the subject Fingerprint Validation System where an Individual 138 requests a fingerprint-based criminal background check on him/herself under the Freedom of Information Act (FOIA). In this scenario, Individual 138 receives the results of the background check. In a preferred embodiment, Individual 138 initiates the process (Action 16) by visiting a Fingerprint Collection Facility (FCF) in order to complete the FOIA paperwork and have his/her fingerprint images, photograph and Driver's License information electronically (or otherwise) captured via first fingerprint collection means 102. The FCF technician uses the FCF Web Browser 136 associated with its Livescan fingerprint capture device 128 or other fingerprint capture means to enter a fingerprint Order (Action 17) via a web-based Order Entry Application 112 of OPS 108. Order Entry Application 112 creates a fingerprint Order in the Order Database 116, and Order Management Application 114 immediately forwards that Order (Action 2) to AFIS Fingerprint Management Application 120, where the Order is stored in AFIS Order Database 118. The FCF technician captures the Applicant's fingerprint images, photograph and Driver's License using the Livescan Fingerprint Capture Device 128 or other fingerprint collection means 102 and transmits (Action 4) the images to the AFIS Fingerprint Management Application 120. AFIS Fingerprint Management Application 120 stores the images in AFIS Fingerprint Database 122. AFIS Fingerprint Management Application 120 further builds a fingerprint-based criminal background check Request from the Fingerprint images on AFIS Fingerprint Database 122 and AFIS Order Database 116 and transmits the Request (Action 5) to the appropriate criminal history Repository 106. Repository 106 performs the background check and sends the CHRI Rapsheet (Action 18) directly to Individual 138 as specified in the fingerprint Order. Repository 106 also sends a CHRI Summary (Action 7) back to the transmitting AFIS Fingerprint Management Application 120. AFIS Fingerprint Management Application 120, after logging the Summary into its AFIS Order Database 118, forwards the CHRI Summary (Action 8) to Order Management Application 114 and the results are stored in Order Database 116 of OPS 108.

After Individual 138 has reviewed the CHRI Rapsheet, Individual 138 submits the CHRI Rapsheet (Action 19) to the prospective Employer 140. Employer 140 uses Fingerprint Validation Device 104 to capture at least one comparison fingerprint from Individual 138, uses web browser 134 to obtain an Order Number from CPAS 100, and then sends a Validation Request (Action 20) to AFIS Fingerprint Management Application 120 for validation of the Rapsheet (i.e., that it relates to Individual 138). AFIS Fingerprint Management Application 120 performs a one-to-one match on the at least one sample fingerprint submitted by Individual 138 against the fingerprints captured in AFIS Fingerprint Database 122 previously used for the background check and returns a response to Employer 140. A positive response (wherein the fingerprints match) indicates to Employer 140 that it was in fact the fingerprints of Individual 138 that were submitted for that Order, thus positively linking Individual 138 with the CHRI Rapsheet he/she provided to the prospective Employer. A negative response indicates a likelihood that a fraudulent set of fingerprints were submitted and further investigation by Employer 140 is required.

Reference is now made to FIG. 6 which illustrates in diagram form another embodiment of the subject Fingerprint Validation System. In this Example, an Applicant has previously had his/her fingerprints electronically captured and stored in the AFIS Fingerprint Database 122 of System Hub 100. The Applicant notifies Authorized End-User 126 that Applicant's fingerprints have been previously entered in AFIS 110 generally, and AFIS Fingerprint Database 122 in particular. Authorized End-User 126, using Fingerprint Validation Device 104, captures at least one and preferably two comparison fingerprints from the Applicant and sends a Validation Request (Action 21) to AFIS Fingerprint Management Application 120 for validation of the Applicant. AFIS Fingerprint Management Application 120 performs a one-to-one match on the fingerprint(s) submitted by Applicant in the presence of Authorized End-User 126 against the fingerprints captured in the AFIS Fingerprint Database 122 and returns a response to Authorized End-User 126. A positive response (wherein the fingerprints match) indicates to Authorized End-User 126 that the Applicant's fingerprints are in the AFIS Fingerprint Database 122. Authorized End-User 126 uses Web Browser 134 to enter a fingerprint Order (Action 22) via web-based Order Entry Application 112. Order Entry Application 112 creates a fingerprint Order in Order Database 116 of OPS 108, and Order Management Application 114 immediately forwards that Order (Action 23) to AFIS Fingerprint Management Application 120 for storage in AFIS Order Database 118. AFIS Fingerprint Management Application 120 then builds a fingerprint-based criminal background check Request from the fingerprint images in the AFIS Fingerprint. Database 122 and AFIS Order Database 118 and transmits the Request (Action 5) to the appropriate criminal history Repository 106. All subsequent processing of the CHRI Rapsheet and Summary is identical to that described in previous Examples.

Although the present invention has been described with reference to the particular embodiments herein set forth, it is understood that the present disclosure has been made only by way of example and that numerous changes in details of construction may be resorted to without departing from the spirit and scope of the invention. Thus, the scope of the invention should not be limited by the foregoing specifications, but rather only by the scope of the claims appended hereto.

What is claimed as being new, useful and desired to be protected by Letters Patent of the united states is as follows:

1. Apparatus for validating the results of a fingerprint-based criminal background investigation of an individual comprising:
means for collecting at least one fingerprint from an individual who is the subject of a fingerprint-based criminal background investigation;
means for comparing said at least one fingerprint with at least one fingerprint used as the basis of said fingerprint-based criminal background investigation; and
means for reporting to an authorized recipient whether said at least one fingerprint from the individual matches said at least one fingerprint used as the basis of said fingerprint-based criminal background investigation, thereby validating or invalidating that said at least one fingerprint used as the basis of said fingerprint-based criminal background investigation was that of the individual being investigated.

2. A method of validating the results of a fingerprint-based criminal background investigation of an individual, the method comprising the steps of:
collecting at least one fingerprint from an individual who is the subject of a fingerprint-based criminal background investigation;
comparing said at least one fingerprint with at least one fingerprint used as the basis of said fingerprint-based criminal background investigation; and
reporting to an authorized recipient whether said at least one fingerprint from the individual matches said at least one fingerprint used as the basis of said fingerprint-based criminal background investigation, thereby validating or invalidating that said at least one fingerprint used as the basis of said fingerprint-based criminal background investigation was that of the individual being investigated.

3. The Apparatus for validating the results of a fingerprint-based criminal background investigation of an individual of claim 1, wherein said means for collecting at least one fingerprint from said individual is a fingerprint capture device located with a party desiring to validate the results of said fingerprint-based criminal background investigation.

4. The Apparatus for validating the results of a fingerprint-based criminal background investigation of an individual of claim 1, wherein said means for comparing said at least one fingerprint with said at least one fingerprint used as the basis of said fingerprint-based criminal background investigation is comprised of an automated fingerprint identification system electronically linked to an order processing system electronically linked to said means for collecting at least one fingerprint from said individual.

5. The method of validating the results of a fingerprint-based criminal background investigation of an individual of claim 2, wherein said step of collecting at least one fingerprint from said individual employs a fingerprint capture device located with a party desiring to validate the results of said fingerprint-based criminal background investigation.

6. The method of validating the results of a fingerprint-based criminal background investigation of an individual of claim 2, wherein said step of comparing said at least one fingerprint with said at least one fingerprint used as the basis of said fingerprint-based criminal background investigation is carried out by an automated fingerprint identification system electronically linked to an order processing system electronically linked to a means for collecting at least one fingerprint from said individual.
